(19) United States
(12) Patent Application Publication
(10) Pub. No.: US 2020/0385519 A1
(43) Pub. Date: Dec. 10, 2020

(54) PROCESS FOR THE MANUFACTURE OF THERMOSETTING POLY(ARYLENE ETHER) COPOLYMER AND COMPOSITIONS

(71) Applicant: SABIC GLOBAL TECHNOLOGIES B.V., BERGEN OP ZOOM (NL)

(72) Inventors: Rajesh Chowdhury, Bangalore (IN); Tarun Kumar Pal, Bangalore (IN); Deshmukh Sandesh Shivajirao, Bangalore (IN); Gaurav Mediratta, Bangalore (IN)

(21) Appl. No.: 16/772,519

(22) PCT Filed: Dec. 13, 2018
(86) PCT No.: PCT/IB2018/060027

§ 371 Date: Jun. 12, 2020

Related U.S. Application Data
(60) Provisional application No. 62/598,056, filed on Dec. 13, 2017.

(51) Int. Cl. C08G 65/48

(52) U.S. Cl. CPC C08G 65/485

(57) ABSTRACT

A process for forming a capped poly(arylene ether) copolymer, the process comprising: combining an acid catalyst and an uncapped poly(arylene ether) composition comprising an uncapped poly(arylene ether) copolymer comprising a phenolic end group ortho-substituted with a (C₁-C₁₂-hydrocarbyl)(C₁-C₁₂-hydrocarbyl)aminomethylene group, to form a first reaction mixture; reacting the (C₁-C₁₂-hydrocarbyl)(C₁-C₁₂-hydrocarbyl)aminomethylene group of the uncapped poly(arylene ether) copolymer in the presence of the acid catalyst under conditions effective to cleave a (C₁-C₁₂-hydrocarbyl)(C₁-C₁₂-hydrocarbyl)amino group from the uncapped poly(arylene ether) copolymer, to form a second reaction mixture; adding a nucleophilic catalyst and a capping agent to the second reaction mixture; and reacting the capping agent and the uncapped poly(arylene ether) copolymer under conditions effective to provide a product mixture comprising the capped poly(arylene ether) copolymer; preferably wherein the (C₁-C₆-hydrocarbyl)(C₁-C₆-hydrocarbyl)aminomethylene group is a di(C₁-C₆-alkyl)aminomethylene group, more preferably di-n-butylaminomethylene or 2-(tert-butyl(2-(tert-butylamino)ethyl)amino)methylene).

### BACKGROUND

Poly(arylene ether) copolymers are a class of thermoplastics known for excellent water resistance, dimensional stability, and inherent flame retardancy, as well as outstanding dielectric properties over wide frequency and temperature ranges. Properties such as ductility, stiffness, chemical resistance, and heat resistance can be tailored by reacting thermosetting poly(arylene ether) copolymers with various crosslinking agents in order to meet requirements of a wide variety of end uses, for example, fluid engineering parts, electrical enclosures, automotive parts, and insulation for wire and cable. In particular, poly(arylene ether) copolymers have been used in thermoset compositions for electronics applications, where they provide improved toughness and dielectric properties, among other benefits.

Thermosetting poly(arylene ether) copolymers are telechelic, in that they are endcapped with reactive groups such as vinyl. Thermosetting poly(arylene ether) copolymers are often therefore referred to as “capped”. Methods for the manufacture of capped poly(arylene ether) copolymers have been described. However, while suitable for their intended purposes, there nonetheless remains a need for improved processes of preparing capped poly(arylene ether) copolymers of higher purity, and in particular capped poly(arylene ether) copolymers having reduced chemical incorporation of dialkylamine co-catalysts. It would be an additional advantage if the processes could be readily incorporated into known methods.

### BRIEF SUMMARY

A process for forming a capped poly(arylene ether) copolymer comprises combining an acid catalyst and an uncapped poly(arylene ether) composition comprising an uncapped poly(arylene ether) copolymer comprising a phenolic end group ortho-substituted with a (C₁-C₁₂-hydrocarbyl)(C₁-C₁₂-hydrocarbyl)aminomethylene group, to form a first reaction mixture; reacting the (C₁-C₁₂-hydrocarbyl)(C₁-C₁₂-hydrocarbyl)aminomethylene group of the uncapped poly(arylene ether) copolymer in the presence of the acid catalyst under conditions effective to cleave a (C₁-C₁₂-hydrocarbyl)(C₁-C₁₂-hydrocarbyl)amino group from the uncapped poly(arylene ether) copolymer, to form a second reaction mixture; adding a nucleophilic catalyst and a capping agent to the second reaction mixture; and reacting the capping agent and the uncapped poly(arylene ether) copolymer under conditions effective to provide a product mixture comprising the capped poly(arylene ether) copolymer; preferably wherein the (C₁-C₆-hydrocarbyl)(C₁-C₆-hydrocarbyl)aminomethylene group is a di(C₁-C₆-alkyl)aminomethylene group, more preferably di-n-butylaminomethylene or 2-(tert-butyl(2-(tert-butylamino)ethyl)amino)methylene).

According to another aspect, a capped poly(arylene ether) copolymer made by the process is provided.

Another aspect provides a curable composition comprising a thermosetting resin and the capped poly(arylene ether) copolymer.

A cured composition can be obtained by heating the curable composition for a time and temperature sufficient to effect curing.

Also provided is an article comprising the cured composition.

These and other aspects are described in detail below.

### DETAILED DESCRIPTION

The present inventors have determined that a telechelic, low molecular weight poly(arylene ether) copolymer can be produced having reduced chemical incorporation of dialkylamine groups into the copolymer. In particular, it has unexpectedly been found that a reduced number of dialkylaminomethylene groups can be attained by cleaving the dialkylamine groups before capping the precursor poly(arylene ether) copolymer with vinyl-containing reactive endgroups. In an advantageous feature, cleaving the dialkylamine groups can be performed using reagents and processes already a part of the capping reaction. The method is accordingly inexpensive and can be run on an industrial scale. The capped poly(arylene ether) copolymers produced by this method have improved properties, for example improved oxidative stability.

In a process for forming an uncapped poly(arylene ether) copolymer used to manufacture the capped poly(arylene ether) copolymers, a monohydric phenol having a methyl group ortho to the phenol oxygen and a dihydric phenol are reacted in the presence of molecular oxygen and a polymerization catalyst comprising a metal ion and at least one amine ligand, to form a copolymer of the monohydric phenol and the dihydric phenol. When the amine ligand comprises a secondary amine such as N,N′-di-tert-butylethylenediamine (DBEDA), di-n-butylamine (DBA), or the like, a portion of the secondary amine can be chemically incorporated as a tertiary amine into the poly(arylene ether) copolymer at the benzylic position of terminal monohydric phenol units. The covalently bound amine groups are present as aminomethylene groups ortho to the phenol oxygen in terminal units as shown in the example below.

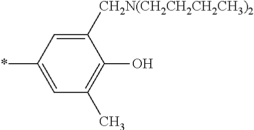

The amount aminomethylene groups can be determined by proton nuclear magnetic resonance (¹H-NMR) spectroscopy. The aminomethylene groups can adversely affect the thermooxidative stability of compositions formed from the capped poly(arylene ether) copolymer, and can result in yellowing upon heat aging, unstable intrinsic viscosity, and increased molar polarization, which if retained in the copolymer backbone, can lead to inferior dielectric performance. Advantageously, the process described herein results in a capped poly(arylene ether) copolymer having a reduced amount of aminomethylene groups in comparison to an analogous process in which the capped poly(arylene ether) copolymer is prepared without the method provided herein.

The process for forming the capped poly(arylene ether) copolymer with a reduced amount of aminomethylene groups comprises combining an acid catalyst and an uncapped poly(arylene ether) composition comprising an uncapped poly(arylene ether) copolymer comprising a phenolic end group ortho-substituted with a (C₁-C₁₂-hydrocarbyl)(C₁-C₁₂-hydrocarbyl)aminomethylene group, to form a first reaction mixture; reacting the (C₁-C₁₂-hydrocarbyl)(C₁-C₁₂-hydrocarbyl)aminomethylene group of the uncapped poly(arylene ether) copolymer in the presence of the acid catalyst under conditions effective to cleave a (C₁-C₁₂-hydrocarbyl)(C₁-C₁₂-hydrocarbyl)amino group from the uncapped poly(arylene ether) copolymer to form a second reaction mixture; adding a nucleophilic catalyst and a capping agent to the second reaction mixture; and reacting the capping agent and the uncapped poly(arylene ether) copolymer under conditions effective to provide a product mixture comprising the capped poly(arylene ether) copolymer.

In the process for forming the capped poly(arylene ether) copolymer with reduced levels of aminomethylene groups, the (C₁-C₁₂-hydrocarbyl)(C₁-C₁₂-hydrocarbyl)aminomethylene group of the uncapped poly(arylene ether) copolymer is combined with an acid catalyst to form the first reaction mixture. Exemplary acid catalysts can be protic acids, including organic and inorganic protic acids, and acid chloride and anhydride precursors thereof, which have a pKa that is less than the pKa of the (C₁-C₁₂-hydrocarbyl)(C₁-C₁₂-hydrocarbyl)aminomethylene group, provided that such acid catalysts do not significantly adversely affect the desired reactivity or properties of the capped copolymer product. For example, the acid catalyst can be adipic acid, L-ascorbic acid, aspartic acid, acetic acid, citric acid, dodecanoic acid, benzoic acid, formic acid, glutamic acid salicylic acid, nicotinic acid, fumaric acid, maleic acid, boric acid, sulfamic acid, acetic anhydride, succinic anhydride, allyl succinic anhydride, propionic anhydride, isobutyric anhydride, isobutenyl succinic anhydride, butenyl succinic anhydride, maleic anhydride, glutaric anhydride, adipic anhydride, salicylic anhydride, phthalic anhydride, acrylic anhydride, methacrylic anhydride, 4-vinylbenzoic anhydride, a corresponding acid chloride thereof, or the like, or a combination thereof.

The acid catalyst can be the corresponding acid of the capping agent, for example the acid catalyst can be prepared by combining the capping agent and the uncapped poly(arylene ether) copolymer under conditions effective to provide the acid catalyst in the first reaction mixture. Without being bound by theory, the capping agent reacts with residual moisture and/or residual N-dibutyl amine present in the poly(arylene ether) copolymer to generate the corresponding acid catalyst. Alternatively, the acid catalyst can be any anhydride or acid halide compound that is capable of hydrolyzing in-situ to generate acids that can cleave the (C₁-C₁₂-hydrocarbyl)(C₁-C₁₂-hydrocarbyl)amino group from the poly(arylene ether) copolymer.

The acid catalyst and the uncapped poly(arylene ether) composition can be combined under conditions effective to cleave the (C₁-C₁₂-hydrocarbyl)(C₁-C₁₂-hydrocarbyl)amino group to form a second reaction mixture. In an aspect, the effective conditions include heating the combined acid catalyst and uncapped poly(arylene ether) composition, for example azeotropic distillation of the first reaction mixture to remove water. The azeotropic distillation can be conducted at a temperature of 70° C. to 200° C., preferably 75° C. to 185° C., more preferably 80° C. to 170° C., and at a pressure of 1 to 10 bar (100 to 1000 kPa), preferably 1 to 6 bar (100 to 600 kPa), more preferably 1 to 4 bar (100 to 400 kPa). The azeotropic distillation time can be from 1 to 10 hours, preferably from 2 to 8 hours, more preferably from 3 to 6 hours. For example, the azeotropic distillation can be at a temperature, pressure, or time that is sufficient to achieve a residual water content of 300 parts per million (ppm) or less, preferably 200 ppm or less, more preferably 150 ppm or less, or from 1 to 300 ppm, preferably 1 to 200 ppm, more preferably from 1 to 150 ppm.

The uncapped poly(arylene ether) composition includes an uncapped poly(arylene ether) copolymer comprising a phenolic end group that can be obtained by reacting a monohydric phenol, for example having a methyl group ortho to the phenol oxygen, and a dihydric phenol in the presence of molecular oxygen and a polymerization catalyst comprising a metal ion and at least one amine ligand. Methods for this process are described, for example, in U.S. Pat. No. 3,306,874 to Hay, U.S. Pat. No. 4,463,164 to Dalton et al., and U.S. Pat. No. 3,789,054 to Izawa et al. The uncapped poly(arylene ether) composition can be a product mixture of the reaction of a monohydric phenol, a dihydric phenol, a metal catalyst, and a (C₁-C₁₂-hydrocarbyl)(C₁-C₁₂-hydrocarbyl)amine.

The monohydric phenol has one hydroxy group bound directly to an aromatic ring. Exemplary monohydric phenols include those phenols having the structure (1)

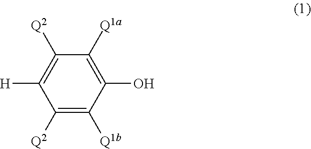

wherein Q^{1a} is a C₁-C₁₂ primary or secondary alkyl; Q^{1b} is halogen, C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Q² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. For example, Q^{1a} can be methyl, and Q^{1b} can be halogen, unsubstituted C₁-C₁₂ alkyl provided that the alkyl group is not tertiary alkyl, or unsubstituted C₁-C₁₂ aryl.

Exemplary monohydric phenols include 2,6-dimethylphenol, 2-methylphenol, 2,5-dimethylphenol, 2,3,6-trimethylphenol, 2-methyl-6-phenyl phenol, or a combination thereof. For example, the monohydric phenol can be 2,6-dimethylphenol.

The dihydric phenol has two hydroxy groups bound directly to the same aromatic ring or to two different aromatic rings within the same molecule. Exemplary dihydric phenols include those having the structure (2)

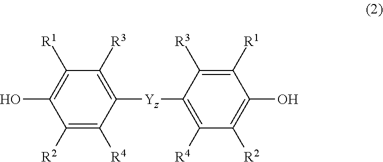

wherein each occurrence of R¹, R², R³, and R⁴ is independently hydrogen, halogen, C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y is a divalent linking group of the formulas

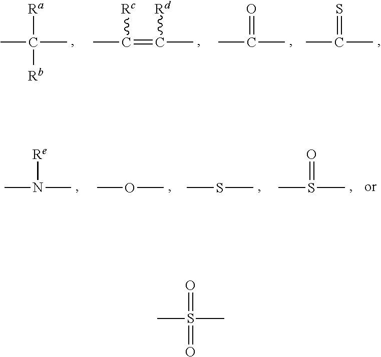

wherein each occurrence of R^{a}, R^{b}, R^{c}, R^{d}, and R^{e} is independently hydrogen, C₁-C₁₂ hydrocarbyl, or C₁-C₆ hydrocarbylene, optionally wherein R^{a} and R^{b} or R^{c} and R^{d} together are a C₄-C₈ alkylene group. When z is 0, the two aryl groups are connected by a single bond. In some aspects, z is 1. Examples of dihydric phenols include 3,3′,5,5′-tetramethyl-4,4′-biphenol, 2,2-bis(3-methyl-4-hydroxyphenyl)propane, 2,2-bis(3,5-dimethy-4-hydroxyphenyl)propane, 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, bis(4-hydroxyphenyl)phenylmethane, 2,2-bis(4-hydroxy-3-methylphenyl)propane, 1,1-bis(4-hydroxy-3-methylphenyl)cyclohexane, 1,1-bis(4-hydroxy-3,5-dimethylphenyl)cyclopentane, 1,1-bis(4-hydroxy-3,5-dimethylphenyl)cyclohexane, 1,1-bis(4-hydroxy-3-methylphenyl)cycloheptane, 1,1-bis(4-hydroxy-3,5-dimethylphenyl)cycloheptane, 1,1-bis(4-hydroxy-3-methylphenyl)cyclooctane, 1,1-bis(4-hydroxy-3,5-dimethylphenyl)cyclooctane, 1,1-bis(4-hydroxy-3-methylphenyl)cyclononane, 1,1-bis(4-hydroxy-3,5-dimethylphenyl)cyclononane, 1,1-bis(4-hydroxy-3-methylphenyl)cyclodecane, 1,1-bis(4-hydroxy-3,5-dimethylphenyl)cyclodecane, 1,1-bis(4-hydroxy-3-methylphenyl)cycloundecane, 1,1-bis(4-hydroxy-3,5-dimethylphenyl)cycloundecane, 1,1-bis(4-hydroxy-3-methylphenyl)cyclododecane, 1,1-bis(4-hydroxy-3,5-dimethylphenyl)cyclododecane, 1,1-bis(4-hydroxy-3-t-butylphenyl)propane, 2,2-bis(4-hydroxy-2,6-dimethylphenyl)propane, 2,2-bis(4-hydroxy-3-bromophenyl)propane, 1,1-bis(4-hydroxyphenyl)cyclopentane, 1,1-bis(4-hydroxyphenyl)cyclohexane, 2,2′,6,6′-tetramethyl-3,3′,5,5′-tetrabromo-4,4′-biphenol, 2,2′,5,5′-tetramethyl-4,4′-biphenol, 2,2-bis(3,5-dimethyl-4-hydroxyphenol)propane, or a combination thereof.

The uncapped poly(arylene ether) copolymer is formed by polymerization of monomers comprising monohydric phenol and dihydric phenol by continuous addition of oxygen to a reaction mixture comprising the monomers, optionally a solvent, and the polymerization catalyst. The molecular oxygen (O₂) can be provided as air or pure oxygen. The polymerization catalyst is a metal complex, i.e. a metal catalyst, comprising a transition metal cation, including cations from Group VIB, VIIB, VIIIB, or IB, or a combination thereof, of the Periodic Table. Exemplary transition metal cations include chromium, manganese, cobalt, copper, or a combination thereof. For example, the transition metal cation is copper (Cu⁺ or Cu²⁺). Transition metal salts can serve as sources of transition metal cations and include cuprous chloride, cupric chloride, cuprous bromide, cupric bromide, cuprous iodide, cupric iodide, cuprous sulfate, cupric sulfate, cuprous tetraamine sulfate, cupric tetraamine sulfate, cuprous acetate, cupric acetate, cuprous propionate, cupric butyrate, cupric laurate, cuprous palmitate, cuprous benzoate, and the corresponding manganese salts and cobalt salts. Instead of use of any of the above-exemplified transition metal salts, it is also possible to add a metal or a metal oxide and an inorganic acid, organic acid or an aqueous solution of such an acid and form the corresponding transition metal salt or hydrate in situ. For example, cuprous oxide and hydrobromic acid can be added to generate cuprous bromide in situ.

The polymerization catalyst further comprises an amine ligand. The amine ligand can be, for example, a monoamine, an alkylene diamine, or the like, or a combination thereof. An exemplary monoamine is a (C₁-C₁₂-hydrocarbyl)(C₁-C₁₂-hydrocarbyl)monoamine wherein each hydrocarbyl group can be the same or different. Preferably, at least one of the C₁-C₁₂-hydrocarbyl groups is an alkyl group. For example, the (C₁-C₆-hydrocarbyl)(C₁-C₆-hydrocarbyl)monoamine can be a di(C₁-C₆-hydrocarbyl)monoamine wherein each hydrocarbyl group is the same, and preferably is an alkyl group. For example, the (C₁-C₆-hydrocarbyl)(C₁-C₆-hydrocarbyl)monoamine can be a di(C₁-C₈-alkyl)monoamine wherein each alkyl group is the same, preferably a di(C₁-C₆-alkyl)monoamine wherein each alkyl group is the same. In some aspects the (C₁-C₁₂-hydrocarbyl)(C₁-C₁₂-hydrocarbyl)monoamine is di-n-butylamine (DBA), n-butylethylamine, di-tert-butylamine, tert-butylethylamine, dimethylamine, di-n-propylamine , di-sec-butyl amine, dipentylamine, dihexylamine, dioctylamine, didecylamine, dibenzylamine, methylethylamine, methylbutylamine, dicyclohexylamine, N-ethylaniline, N-butylaniline, N-methyl-2-methylaniline, N-methyl-2,6-dimethylaniline, diphenylamine, or the like, or a combination thereof. Diamines include alkylenediamines, such as N,N′-di-tert-butylethylenediamine (DBEDA). Exemplary trialkylmonoamines include trimethylamine, triethylamine, tripropylamine, tributylamine, butyldimethylamine, phenyldiethylamine, or the like, or a combination thereof.

The solvent can include, based on the total weight of the solvent, at least 95 weight percent (wt %) of a C₁-C₃ alcohol selected from methanol, ethanol, 1-propanol, 2-propanol, or a combination thereof. Within this range, the solvent can comprise at least 98 wt %, or at least 99 wt %, or at least 99.9 wt % of the C₁-C₃ alcohol. The solvent can comprise less than 5 wt %, specifically less than 2 wt %, or less than 1 wt %, or less than 0.1 wt % of a solvent other than the C₁-C₃ alcohol. For example, the solvent other than the C₁-C₃ alcohol can comprise water introduced as a solution of the metal cation or salt, for example Cu₂O, or toluene introduced as a solution of an amine ligand, for example di-tert-butylethylenediamine in toluene. For example, the C₁-C₃ alcohol can be methanol, and the solvent comprises at least 99 wt % methanol.

The reaction to form the uncapped poly(arylene ether) copolymer results in a composition comprising an uncapped poly(arylene ether) copolymer having two phenolic end groups and an uncapped poly(arylene ether) copolymer comprising a phenolic end group that is ortho-substituted with a (C₁-C₆-hydrocarbyl)(C₁-C₆-hydrocarbyl)aminomethylene group. For convenience, this composition is also referred to herein as an uncapped poly(arylene ether) composition. The reaction to form the uncapped poly(arylene ether) copolymer can provide an uncapped poly(arylene ether) composition comprising an uncapped poly(arylene ether) copolymer of formula (3)

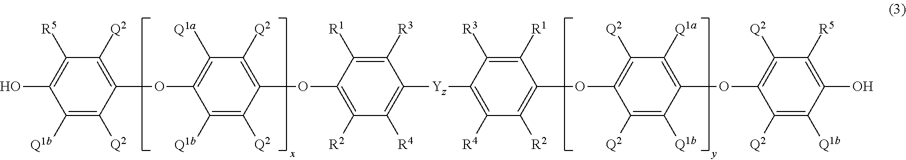

wherein Q^{1a}, Q^{1b}, Q², R¹, R², R³, R⁴, Y, and z are as described in formulas (1) and (2). Further in formula (3), each occurrence of R⁵ is independently Q^{1a} or a (C₁-C₆-hydrocarbyl)(C₁-C₆-hydrocarbyl)aminomethylene group, with the proviso that at least 50 parts per million (ppm) by weight of the R⁵ groups are (C₁-C₆-hydrocarbyl)(C₁-C₆-hydrocarbyl)aminomethylene groups, based on the total parts by weight of the uncapped poly(arylene ether) copolymer. For example, at least 75 ppm, at least 100 ppm, at least 150 ppm, at least 250 ppm, at least 300 ppm, at least 400 ppm, or 50 to 500 ppm, 50 to 1,000 ppm, or 50 to 3,000 ppm of the of the R⁵ groups are (C₁-C₆-hydrocarbyl)(C₁-C₆-hydrocarbyl)aminomethylene groups, based on the total parts by weight of the uncapped poly(arylene ether) copolymer. For example, at least 50 ppm of the R⁵ groups are a di(C₁-C₆-alkyl)aminomethylene group, preferably di-n-butylaminomethylene or 2-((tert-butyl(2-(tert-butylamino)ethyl)amino)methylene).

In formula (3), x and y represent the relative mole ratios of the respective phenylene ether units. For example, x and y are each independently 0 to 50, provided that the sum of x and y is 4 to 53, preferably 8 to 20, more preferably 8 to 15, even more preferably 8 to 10.

The uncapped poly(arylene ether) copolymer (3) can comprise 80 to 99 wt % of repeat units derived from the monohydric phenol (1) and 1 to 20 wt % of repeat units derived from the dihydric phenol (2). Within this range, the uncapped poly(arylene ether) copolymer can comprise 85 to 95 wt % of repeat units derived from the monohydric phenol (1) and 5 to 15 wt % of repeat units derived from the dihydric phenol (2).

For example, the monohydric phenol can comprise 2,6-dimethylphenol; the dihydric phenol can comprises 2,2-bis(3,5-dimethyl-4-hydroxyphenol)propane; at least one amine ligand can comprise di(n-butyl)amine; and an uncapped poly(arylene ether) copolymer product of 2,6-dimethylphenol and 2,2-bis(3,5-dimethyl-4-hydroxyphenol)propane can be of formula (3a):

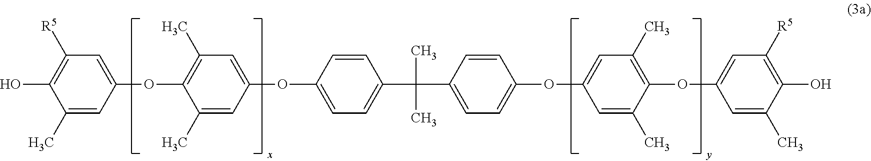

wherein each occurrence of R⁵ is independently methyl or a di-(n-butyl)aminomethylene group, with the proviso that at least 50 ppm by weight of the R⁵ groups are di-(n-butyl)aminomethylene groups. For example, each occurrence of R⁵ is independently methyl or a 2-((tert-butyl(2-(tert-butylamino)ethyl)amino)methylene) group, with the proviso that at least 50 ppm by weight of the R⁵ groups are 2-((tert-butyl(2-(tert-butylamino)ethyl)amino)methylene) groups.

The absolute number average molecular weight (Mₙ) of the uncapped poly(arylene ether) copolymer is 300 to 25,000 grams per mole (g/mol). For example, the copolymer has an absolute Mₙ of 300 to 10,000 g/mol, specifically 300 to 8,000 g/mol, or 300 to 5,000 g/mol, or 300 to 3,000 g/mol.

The capped poly(arylene ether) copolymer is formed by the reaction of an uncapped poly(arylene ether) copolymer, for example an uncapped poly(phenylene ether) copolymer, with a capping agent. The capping agent can be an anhydride capping agent, an acid halide capping agent, or a combination thereof. For example, the capping agent can be an anhydride or a corresponding acid chloride of the formula (4)

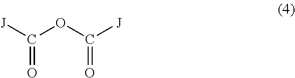

wherein each occurrence of J is independently

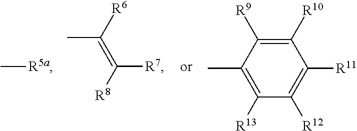

wherein R^{5a} is C₁-C₁₂ hydrocarbyl optionally substituted with one or two carboxylic acid groups, or the like; each occurrence of R⁶, R⁷, and R⁸ is independently hydrogen, C₁-C₁₈ hydrocarbyl, C₂-C₁₈ hydrocarbyloxycarbonyl, nitrile, formyl, carboxylic acid, imidate, thiocarboxylic acid, or the like; and each occurrence of R⁹, R¹⁰, R¹¹, R¹², and R¹³ is independently hydrogen, halogen, C₁-C₁₂ alkyl, C₂-C₁₂ alkenyl, hydroxy, amino, carboxylic acid, or the like. Examples of capping agents include, for example, acetic anhydride, succinic anhydride, allyl succinic anhydride, propionic anhydride, isobutyric anhydride, isobutenyl succinic anhydride, butenyl succinic anhydride, maleic anhydride, glutaric anhydride, adipic anhydride, salicylic anhydride, phthalic anhydride, acrylic anhydride, methacrylic anhydride, 4-vinylbenzoic anhydride, a corresponding acid chloride thereof, or the like, or a combination thereof. It will be understood that the capping agent further includes diacids capable of forming the corresponding cyclic anhydride under the capping reaction conditions.

For example, the capping agent can have the structure of formula (4a):

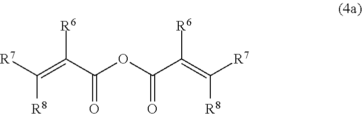

wherein each occurrence of R⁶, R⁷, and R⁸ is independently C₁-C₁₈ hydrocarbyl, C₂-C₁₂ hydrocarbyloxycarbonyl, nitrile, formyl, carboxylic acid, imidate, thiocarboxylic acid, or the like. In another aspect, the capping agent comprises acrylic anhydride, methacrylic anhydride, or a combination thereof.

Methods of reacting an uncapped poly(arylene ether) copolymer having phenolic end groups with a capping agent are described, for example, in U.S. Pat. No. 3,375,228 to Holoch et al.; U.S. Pat. No. 4,148,843 to Goossens, U.S. Pat. No. 4,806,602 to White et al.; U.S. Pat. No. 5,219,951 to Nelissen et al.; U.S. Pat. No. 6,384,176 to Braat et al; U.S. Patent Application Publication No. 2001/0053820 A1 to Yeager et al.; and European Patent No. 261,574 B1 to Peters et al.

A nucleophilic catalyst is used in the reaction of the uncapped poly(arylene ether) copolymer with the capping agent. Examples of such catalysts include those that are capable of catalyzing condensation of phenols with the capping agents described above. Exemplary nucleophilic catalysts include, but are not limited to, basic compounds including, for example, hydroxide salts such as sodium hydroxide, potassium hydroxide, tetraalkylammonium hydroxides, or the like; tertiary alkylamines such as tributylamine, triethylamine, dimethylbenzylamine, dimethylbutylamine, or the like; tertiary mixed alkyl-arylamines and substituted derivatives thereof such as N,N-dimethylaniline, or the like; heterocyclic amines such as imidazoles, pyridines, and substituted derivatives thereof such as 2-methylimidazole, 2-vinylimidazole, 4-dimethylaminopyridine (DMAP), 4-(1-pyrrolino)pyridine, 4-(1-piperidino)pyridine, 2-vinylpyridine, 3-vinylpyridine, 4-vinylpyridine, or the like; or a combination thereof.

For example, the nucleophilic catalyst can be an organic amine catalyst. Preferred organic amine catalysts include, for example, tertiary alkylamines, tertiary mixed alkyl-aryl amines, heterocyclic amines, or the like. It will be understood that the organic amine catalyst includes ammonium ions formed by protonation of the organic amine. An exemplary capping catalyst comprises a 4-dialkylaminopyridine having the structure (I)

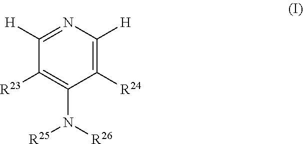

wherein R²³ and R²⁴ are each independently hydrogen or C₁-C₆ alkyl, and R²⁵ and R²⁶ are each independently C₁-C₆ alkyl. For example, the nucleophilic catalyst comprises 4-dimethylaminopyridine (DMAP).

The capping reactions can be performed in a solvent, for example aromatic hydrocarbons such as toluene or xylene or chlorinated aromatic hydrocarbons such as chlorobenzene, o-dichlorobenzene, 1,2,4-trichlorobenzene, or the like. For example, the solvent is toluene.

The capping agent and the nucleophilic catalyst both can be added to the second reaction mixture at the same time. Alternatively, the capping agent can be added after the nucleophilic catalyst is added to the second reaction mixture.

For example, the capped poly(arylene ether) copolymer can have the formula (5):

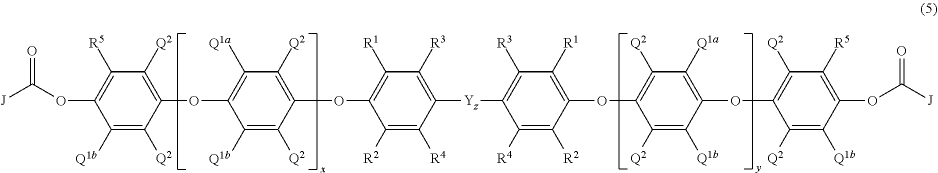

wherein Q^{1a} is a C₁-C₁₂ primary or secondary alkyl, Q^{1b} is halogen, C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms, each occurrence of Q² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms, each occurrence of R¹, R², R³, and R⁴ is independently hydrogen, halogen, C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; z is 0 or 1; x and y represent the relative mole ratios of the arylene ether units as described for formula (3); and Y is divalent linking group of the formulas

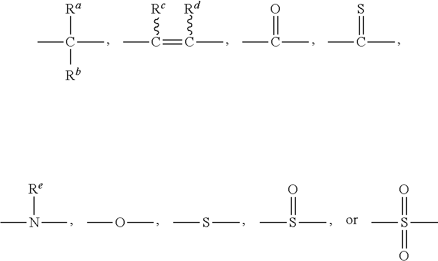

wherein each occurrence of R^{a}, R^{b}, R^{c}, R^{d}, and R^{e} is independently hydrogen, C₁-C₁₂ hydrocarbyl, or C₁-C₆ hydrocarbylene, optionally wherein R^{a} and R^{b} or R^{c} and R^{d} together are a C₄-C₈ alkylene group; each occurrence of R⁵ is independently Q^{1a} or a (C₁-C₆-hydrocarbyl)(C₁-C₆-hydrocarbyl)aminomethylene group, with the proviso that less than 500 ppm, preferably less than 100 ppm, more preferably less than 50 ppm, even more preferably less than 20 ppm by weight of the R⁵ groups are (C₁-C₆-hydrocarbyl)(C₁-C₆-hydrocarbyl)aminomethylene groups, based on the total parts by weight of the copolymer; and J is as defined in formula (4). For example, less than 100 ppm or less than 20 ppm by weight of the R⁵ groups are (C₁-C₆-hydrocarbyl)(C₁-C₆-hydrocarbyl)aminomethylene groups, based on the total parts by weight of the copolymer.

For example, the capped poly(arylene ether) copolymer can be a capped poly(arylene ether) copolymer of the formula (5a)

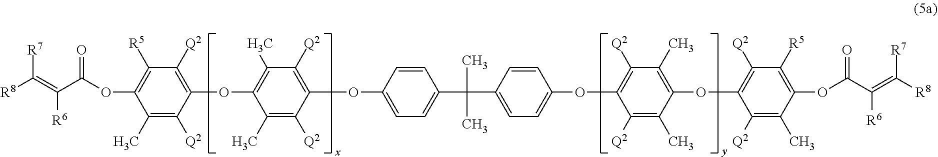

wherein Q², R⁶, R⁷, R⁸, x, and y are as in formula (5), each occurrence of R⁵ is independently C₁-C₁₂ primary or secondary alkyl or a (C₁-C₆-hydrocarbyl)(C₁-C₆-hydrocarbyl)aminomethylene group, with the proviso that less than 500 ppm, preferably less than 100 ppm, more preferably less than 50 ppm, even more preferably less than 20 ppm by weight of the R⁵ groups are (C₁-C₆-hydrocarbyl)(C₁-C₆-hydrocarbyl)aminomethylene groups. For example, less than 100 ppm or less than 20 ppm by weight of the R⁵ groups are (C₁-C₆-hydrocarbyl)(C₁-C₆-hydrocarbyl)aminomethylene groups, based on the total parts by weight of the copolymer of the formula (5a).

The capped poly(arylene ether) copolymer is defined herein as a poly(arylene ether) copolymer in which at least 50%, preferably at least 75%, more preferably at least 90%, yet more preferably at least 95%, even more preferably at least 99%, of the free hydroxyl groups present in the corresponding uncapped poly(arylene ether) copolymer have been functionalized by reaction with a capping agent.

There is no particular limitation on the molecular weight or intrinsic viscosity of the capped poly(arylene ether) copolymer. For example, the capped poly(arylene ether) copolymer can haves an absolute Mₙ of 500 to 25,000 g/mol, preferably 500 to 10,000 g/mol, more preferably 500 to 5,000 g/mol, even more preferably 500 to about 2,900 g/mol, or 800 to 2,200 g/mol, or 1,000 to 1,600 g/mol, as determined by Gel Permeation Chromatography (GPC). The capped poly(arylene ether) copolymer can have an intrinsic viscosity (I.V.) ranging from 0.04 to 1.5 dL/g, from 0.04 to 1.2 dL/g, preferably 0.055 to 0.095 dL/g, as measured in chloroform at 25° C.

The process can further include isolating the capped poly(arylene ether) copolymer from the product mixture. Exemplary methods include precipitation and total isolation methods. A total isolation process can be used for isolating the capped poly(arylene ether) copolymer when the I.V. is less than about 0.25 deciliters per gram (dL/g) as measured in chloroform at 25° C. As part of the total isolation, a portion of the solvent is preferably removed in order to reduce the solvent load on the total isolation equipment. Concentration of the copolymer containing solution is preferably accomplished by reducing the pressure in a solvent flash vessel while preferably increasing the temperature of the copolymer containing solution. The isolated copolymer can further be dried at elevated temperatures, for example at 80° C. to 160° C., preferably at 100° C. to 140° C. for 6 to 24 hours, preferably 8 to 16 hours.

The disclosed process provides for the removal or reduction of the (C₁-C₁₂-hydrocarbyl)(C₁-C₁₂-hydrocarbyl)aminomethylene groups from at least some of the uncapped poly(arylene ether) copolymer. The removal can be quantified by measuring and comparing the amount of aminomethylene groups in both the first reaction mixture that includes an acid catalyst and an uncapped poly(arylene ether) composition comprising an uncapped poly(arylene ether) copolymer comprising a phenolic end group ortho-substituted with a (C₁-C₁₂-hydrocarbyl)(C₁-C₁₂-hydrocarbyl)aminomethylene group, and the second reaction mixture that is obtained after reaction in the presence of the acid catalyst. For example, the capped poly(arylene ether) copolymer in the product mixture comprises at least 80% fewer, preferably at least 90% fewer, even more preferably at least 95% fewer (C₁-C₆-hydrocarbyl)(C₁-C₆-hydrocarbyl)aminomethylene groups than the uncapped poly(arylene ether) copolymer in the first reaction mixture, each as determined by proton nuclear magnetic resonance (¹H NMR) spectroscopy. For example, the capped poly(arylene ether) copolymer in the product mixture comprises no (C₁-C₆-hydrocarbyl)(C₁-C₆-hydrocarbyl)aminomethylene groups as determined by ¹H NMR.

The capped poly(arylene ether) copolymer may be used as a reactive component in curable compositions comprising a thermosetting resin. Thus a curable composition comprises a thermosetting resin and the capped poly(arylene ether) copolymer described herein. The thermosetting resin can be, for example, an epoxy resin, a cyanate ester resin, a bismaleimide resin, a polybenzoxazine resin, a vinyl resin, a phenolic resin, an alkyd resin, an unsaturated polyester resin, or a combination thereof. Exemplary epoxy resins useful as thermosetting resins can be produced by reaction of phenols or polyphenols with epichlorohydrin to form polyglycidyl ethers. Examples of phenols for production of epoxy resins include substituted bisphenol A, bisphenol F, hydroquinone, resorcinol, tris-(4-hydroxyphenyl)methane, and novolac resins derived from phenol or o-cresol. Epoxy resins can also be produced by reaction of aromatic amines, such as p-aminophenol or methylenedianiline, with epichlorohydrin to form polyglycidyl amines.

Epoxy resins can be converted into solid, infusible, and insoluble three dimensional networks by curing with cross-linkers, often called curing agents, or hardeners. Curing agents are either catalytic or coreactive. Coreactive curing agents have active hydrogen atoms that can react with epoxy groups of the epoxy resin to form a cross-linked resin. The active hydrogen atoms can be present in functional groups comprising primary or secondary amines, phenols, thiols, carboxylic acids, or carboxylic acid anhydrides. Examples of coreactive curing agents for epoxy resins include aliphatic and cycloaliphatic amines and amine-functional adducts with epoxy resins, Mannich bases, aromatic amines, polyamides, amidoamines, phenalkamines, dicyandiamide, polycarboxylic acid-functional polyesters, carboxylic acid anhydrides, amine-formaldehyde resins, phenol-formaldehyde resins, polysulfides, polymercaptans, or a combination thereof. A catalytic curing agent functions as an initiator for epoxy resin homopolymerization or as an accelerator for coreactive curing agents. Examples of catalytic curing agents include tertiary amines, such as 2-ethyl-4-methylimidazole, Lewis acids, such as boron trifluoride, and latent cationic cure catalysts, such as diaryliodonium salts.

The thermosetting resin can be a cyanate ester. Cyanate esters are compounds having a cyanate group (—O—C≡N) bonded to carbon via the oxygen atom, i.e. compounds with C—O—C≡N groups. Cyanate esters useful as thermosetting resins can be produced by reaction of a cyanogen halide with a phenol or substituted phenol. Examples of useful phenols include bisphenols utilized in the production of epoxy resins, such as bisphenol A, bisphenol F, and novolac resins based on phenol or o-cresol. Cyanate ester prepolymers are prepared by polymerization/cyclotrimerization of cyanate esters. Prepolymers prepared from cyanate esters and diamines can also be used. The thermosetting resin can be a bismaleimide. Bismaleimide resins can be produced by reaction of a monomeric bismaleimide with a nucleophile such as a diamine, aminophenol, or amino benzhydrazide, or by reaction of a bismaleimide with diallyl bisphenol A. The thermoset resin can be a vinyl resin. A vinyl resin is a monomer or polymer having ethylenic unsaturation. Examples of vinyl resins include unsaturated polyesters, styrenic monomers, (meth)acrylates, allyl ethers, vinyl ethers, or a combination thereof.

Preferably, the curable composition comprises 5 to 95 wt % of the capped poly(arylene ether) copolymer and 5 to 95 wt % of a thermosetting resin, based on the total weight of the curable composition.

The curable compositions can contain a catalyst in quantities effective for curing the composition. The effective amount can be 0.5 to 10 wt %, preferably 1 to 5 wt %, based on the total weight of the curable composition.

The curable composition can further contain flame retardants, flame retardant synergists such as antimony pentoxide; antioxidants, thermal and ultraviolet stabilizers, lubricants, anti-static agents, dyes, pigments, curing agents, reinforcing materials and other constituents, or the like. The thermosetting components, such as those described above, may be used either alone or in combination with one another or with another thermoplastic resin.

A cured composition can be obtained by heating the curable composition defined herein for a time and temperature sufficient to effect curing. For example, the temperature for thermal cure can be from 10° C. to 325° C. and the curing time can be 1 minute to 6 hours. In curing, a cross-linked, three-dimensional polymer network is formed. For certain thermosetting resins, for example (meth)acrylate resins, curing can also take place by irradiation with actinic radiation at a sufficient wavelength and time. For example, the curing of a curable composition containing a UV photoinitiator may be carried out under a predetermined amount of UV light source for a period of time sufficient to cure the composition, and the curing conditions may be dependent on the photoinitiator used in the curable composition.

Due to the presence of the capped poly(arylene ether) copolymer, the cured composition can have any of several beneficial physical properties that are useful in various articles, including good impact strength, hydrolytic stability, low moisture absorption, high glass transition temperature (T_{g}), and good dielectric properties. Thus, an article can comprise the cured composition obtained, for example, by heating the curable composition defined herein for a time and temperature sufficient to effect curing.

The curable article can comprise a fibrous substrate (woven or non-woven) such as glass, quartz, polyester, polyimide, polypropylene, cellulose, carbon fibers and carbon fibrils, nylon or acrylic fibers, preferably a glass substrate, that is impregnated with the curable composition (i.e., prepregs). For the formation of prepregs, the curable composition can be dissolved in an effective amount of an organic solvent, for example toluene, applied to the substrate, and then the organic solvent can be removed by evaporation or the like.

The curable composition can also be used in applications including electronic applications such as capillary underfill formulations and electrically conductive adhesive formulations. The curable composition can be also used as clean resin or clean reactive diluent for electronic applications or as a reactive diluent for composite applications, electrically conductive adhesive (ECA) formulations, and for UV cure applications (i.e. coatings), UV cure formulations for inks and coatings, and laminate applications such as copper clad laminates. For example, the curable composition can be used in solder masks, coatings for photolithography, conductive inks, and adhesives.

The disclosure is further illustrated by the following examples, which are not intended to limit the claims.

### EXAMPLES

Components used in the examples are summarized in Table 1.

TABLE 1

| Component | Description |
|---|---|
| SA90 | NORYL ™ SA90 resin, uncapped copolymer derived from 2,6-dimethylphenol and 2,2- |
| | bis(3,5-dimethyl-4-hydroxyphenol)propane and comprising a phenolic end group ortho- |
| | substituted with a di-n-butylaminomethylene group (“external Mannich amine”; amount |
| | is specified in Table 2); obtained from SABIC. |
| SA9000 | NORYL ™ SA9000 resin, methacrylate-capped poly(phenylene ether) copolymer; |
| | obtained from SABIC or as a product of the present work. |
| DMAP | N,N-Dimethylpyridin-4-amine, CAS Reg. No. 1122-58-3; obtained from Sigma-Aldrich. |
| MAA | Methacrylic anhydride, CAS Reg. No. 760-93-0; obtained from Sigma-Aldrich. |
| Toluene | Toluene, CAS Reg. No. 108-88-3; obtained from Merck. |

### Physical Methods

Proton nuclear magnetic resonance (¹H-NMR) spectra were collected on a Bruker QE-300 MHz NMR spectrometer using CDCl₃ solvent and a tetramethylsilane (TMS) internal standard. The external Mannich amines were quantified in parts per million (ppm) by observing the chemical shifts of the two benzylic protons attached to the nitrogen that appeared at 3.63 ppm in ¹H-NMR spectra.

### Examples 1, 2, and 4

The uncapped copolymer SA90 was combined upfront with MAA (2.094 wt %) in toluene in a reaction vessel. The combination was subjected to azeotropic distillation at 110° C. for 3 hours to remove residual water. DMAP was subsequently added to the vessel with stirring. Once all solids appeared to dissolve, two equivalents of MAA (based on the amount of SA90) were gradually added. The resulting solution was maintained at 116° C. for 7 hours with continuous mixing. The solution was then cooled to room temperature (23° C.) to yield a toluene solution of the capped copolymer SA9000. Methanol was then added to the solution and the capped copolymer was precipitated from solution, isolated, and then dried at 110° C. for 12 hours.

### Example 3

The uncapped copolymer SA90 was combined upfront with MAA (0.412 wt %) in toluene in a reaction vessel. The combination was subjected to azeotropic distillation at 110° C. for 3 hours to remove residual water. DMAP was subsequently added to the vessel with stirring. Once all solids appeared to dissolve, two equivalents of MAA (based on the amount of SA90) were gradually added. The resulting solution was maintained at 116° C. for 7 hours with continuous mixing. The solution was then cooled to room temperature (23° C.) to yield a toluene solution of the capped copolymer SA9000. Methanol was added and the capped copolymer was precipitated from solution, isolated, and then dried at 110° C. for 12 hours.

### Example 5

The uncapped copolymer SA90 was combined with toluene in a reaction vessel.

The combination was subjected to azeotropic distillation at 110° C. for 3 hours to remove residual water. MAA (2.094 wt %) was then added to the reaction vessel at the end of the azeotropic distillation, and the temperature was maintained at 110° C. for an additional 45 minutes. DMAP was subsequently added to the vessel with stirring. Once all solids appeared to dissolve, two equivalents of MAA (based on the amount of SA90) were gradually added. The resulting solution was maintained at 116° C. for 7 hours with continuous mixing. The solution was then cooled to room temperature (23° C.) to yield a toluene solution of the capped copolymer SA9000. Methanol was added and the capped copolymer was precipitated from solution, isolated, and then dried at 110° C. for 12 hours.

### Comparative Examples 1 and 2

Comparative Examples 1 and 2 followed the same procedure used in Examples 1 to 3, except no MAA was added prior to azeotropic distillation or before the solids appeared to dissolve. In other words, two equivalents of MAA were added after azeotropic distillation and the solids appeared to dissolve, but MAA was not added “upfront” before azeotropic distillation (i.e., Examples 1 to 4) or before the solids appeared to dissolve (i.e., Example 5).

### Removal of Mannich Amines

The external Mannich amines were quantified by ¹H-NMR spectroscopy. “Mannich Amines (wt %)” is the content of di-n-butylamino groups incorporated into either SA90 or SA9000, expressed as weight percent based on the weight of SA90 or SA9000, and determined by ¹H-NMR spectroscopy prior to the addition of DMAP. In each of Examples 1-4, an upfront amount of MAA was added at the beginning of the azeotropic cycle, and is expressed as weight percent based on the weight of SA90. In Example 5, the upfront amount of MAA (as weight percent based on the weight of SA90) was added at the end of a three hour azeotropic cycle, followed by 45 minutes of heating at 110° C. before addition of DMAP. In Comparative Examples 1 and 2, no MAA was added upfront. The results are reported in Table 2.

TABLE 2

| | | | Mannich |
|---|---|---|---|
| | | Mannich | Amines (ppm) |
| | MAA (wt %) | Amines (ppm) | Capped Co- |
| Sample | Added upfront | SA90 | polymer Product |
| Example 1 | 2.094 | 943 | nd^{†} |
| Example 2 | 2.094 | 1270 | nd^{†} |
| Example 3 | 0.412 | 901 | nd^{†} |
| Example 4 | 2.094 | 901 | nd^{†} |
| Example 5 | 2.094 | 943 | nd^{†} |
| Comparative Example 1 | 0 | 943 | 232 |
| Comparative Example 2 | 0 | 901 | 385 |

^{†}nd: not detected by ¹H-NMR

The results illustrate the in-process removal of the ortho-methyl (Mannich) terminal amines from SA90 resins before capping with MAA is initiated. In Examples 1-4, the presence of Mannich amines was undetectable in the capped poly(phenylene ether) copolymer when MAA was included during azeotropic distillation prior to adding DMAP. Example 5 showed that a similar result could be obtained by the addition of MAA with continued heating after azeotropic distillation. In Comparative Examples 1 and 2, the concentration of Mannich amines was reduced by azeotropic distillation, however a considerable amount of Mannich amines were evident in the capped poly(phenylene ether) copolymers.

In each example, MAA catalyzed protonation and subsequent cleavage of the Mannich amines during azeotropic distillation before the nucleophilic catalyst DMAP is introduced into the reaction system. Under these conditions, the residual moisture and/or the DBA present in the system generates methacrylic acid in-situ by reacting with MAA. The in-situ generated methacrylic acid initially protonates the nitrogen of the Mannich amine and subsequently cleaves DBA from the poly(phenylene ether) backbone.

This disclosure is further illustrated by the following aspects, which are not intended to limit the claims.

Aspect 1. A process for forming a capped poly(arylene ether) copolymer, the process comprising: combining an acid catalyst and an uncapped poly(arylene ether) composition comprising an uncapped poly(arylene ether) copolymer comprising a phenolic end group ortho-substituted with a (C₁-C₁₂-hydrocarbyl)(C₁-C₁₂-hydrocarbyl)aminomethylene group, to form a first reaction mixture; reacting the (C₁-C₁₂-hydrocarbyl)(C₁-C₁₂-hydrocarbyl)aminomethylene group of the uncapped poly(arylene ether) copolymer in the presence of the acid catalyst under conditions effective to cleave a (C₁-C₁₂-hydrocarbyl)(C₁-C₁₂-hydrocarbyl)amino group from the uncapped poly(arylene ether) copolymer, to form a second reaction mixture; adding a nucleophilic catalyst and a capping agent to the second reaction mixture; and reacting the capping agent and the uncapped poly(arylene ether) copolymer under conditions effective to provide a product mixture comprising the capped poly(arylene ether) copolymer.

Aspect 2. The process of Aspect 1, wherein the capping agent comprises an anhydride capping agent, an acid halide capping agent, or a combination thereof.

Aspect 3. The process of Aspect 1, wherein the acid catalyst is the corresponding acid of the capping agent.

Aspect 4. The process of Aspect 3, further comprising combining the capping agent and the uncapped poly(arylene ether) copolymer under conditions effective to provide the acid catalyst in the first reaction mixture.

Aspect 5. The process of any one or more of the preceding Aspects, wherein the conditions effective to cleave the (C₁-C₁₂-hydrocarbyl)(C₁-C₁₂-hydrocarbyl)amino group comprise azeotropic distillation of water from the first reaction mixture at a temperature of 70 to 200° C. and a pressure of 1 to 10 bar.

Aspect 6. The process of any one or more of the preceding Aspects, wherein the uncapped poly(arylene ether) composition is a product mixture of the reaction of a monohydric phenol, a dihydric phenol, a metal catalyst, and a (C₁-C₁₂-hydrocarbyl)(C₁-C₁₂-hydrocarbyl)amine.

Aspect 7. The process of any one or more of the preceding Aspects, wherein the capping agent comprises an anhydride, or a corresponding acid chloride, of formula (4), wherein J, R^{5a}, R⁶, R⁷, R⁸, R⁹, R¹⁰, R¹¹, R¹², and R¹³ are as provided herein.

Aspect 8. The process of any one or more of the preceding Aspects, wherein the capping agent has the formula (4a), wherein R⁶, R⁷, and R⁸ are as provided herein.

Aspect 9. The process of any one or more of the preceding Aspects, wherein the capping agent is acetic anhydride, succinic anhydride, allyl succinic anhydride, propionic anhydride, isobutyric anhydride, isobutenyl succinic anhydride, butenyl succinic anhydride, maleic anhydride, glutaric anhydride, adipic anhydride, salicylic anhydride, phthalic anhydride, acrylic anhydride, methacrylic anhydride, 4-vinylbenzoic anhydride, a corresponding acid chloride thereof, or a combination thereof.

Aspect 10. The process of any one or more of the preceding Aspects, wherein the uncapped poly(arylene ether) composition comprises an uncapped poly(phenylene ether) copolymer of the formula (3), wherein Q^{1a}, Q^{1b}, Q², R¹, R², R³, R⁴, R⁵, R^{a}, R^{b}, R^{c}, R^{d}, R^{e}, Y, x, y, and z are as provided herein, with the proviso that at least 50 ppm by weight of the R⁵ groups are (C₁-C₆-hydrocarbyl)(C₁-C₆-hydrocarbyl)aminomethylene groups, based on the total parts by weight of the copolymer.

Aspect 11. The process of any one or more of the preceding Aspects, wherein the (C₁-C₆-hydrocarbyl)(C₁-C₆-hydrocarbyl)aminomethylene group is a di(C₁-C₆-alkyl)aminomethylene group, preferably di-n-butylaminomethylene or 2-(tert-butyl(2-(tert-butylamino)ethyl)amino)methylene).

Aspect 12. The process of any one or more of the preceding Aspects, wherein the capping agent is acrylic anhydride, methacrylic anhydride, or a combination thereof; and the uncapped poly(arylene ether) composition comprises an uncapped poly(phenylene ether) copolymer of the formula (3a), wherein R⁵, x, and y are as provided herein, with the proviso that at least 50 ppm by weight of the R⁵ groups are di-(n-butyl)aminomethylene groups.

Aspect 13. The process of any one or more of the preceding Aspects, further comprising isolating the capped poly(arylene ether) copolymer from the product mixture.

Aspect 14. The process of any one or more of Aspects 1 to 13, wherein the capped poly(arylene ether) copolymer in the product mixture comprises at least 80% fewer (C₁-C₆-hydrocarbyl)(C₁-C₆-hydrocarbyl)aminomethylene groups than the uncapped poly(arylene ether) copolymer in the first reaction mixture, each as determined by ¹H NMR.

Aspect 15. The process of any one or more of the preceding Aspects, wherein the capped poly(arylene ether) copolymer in the product mixture comprises no (C₁-C₆-hydrocarbyl)(C₁-C₆-hydrocarbyl)aminomethylene groups as determined by ¹H NMR.

Aspect 16. The process of any one or more of the preceding Aspects, wherein the capped poly(arylene ether) copolymer has an absolute number average molecular weight of 500 to 25,000 grams per mole, preferably 500 to 10,000 grams per mole, more preferably 500 to 5,000 grams per mole, as determined by Gel Permeation Chromatography; and an intrinsic viscosity from 0.04 to 1.5 dL/g, of 0.04 to 1.3 deciliters/gram, preferably 0.055 to 0.095 deciliters/gram, as measured in chloroform at 25° C.

Aspect 17. A capped poly(arylene ether) copolymer made by the method of any one or more of the preceding Aspects, and having the formula (5), wherein Q^{1a}, Q^{1b}, Q², R¹, R², R³, R⁴, R^{5a}, R⁶, R⁷, R⁸, R⁹, R¹⁰, R¹¹, R¹², R¹³, J, x, and y are as defined herein; and each occurrence of R⁵ is independently Q^{1a} or a (C₁-C₆-hydrocarbyl)(C₁-C₆-hydrocarbyl)aminomethylene group, wherein less than 100 parts per million by weight of the R⁵ groups are (C₁-C₆-hydrocarbyl)(C₁-C₆-hydrocarbyl)aminomethylene groups, based on the total parts by weight of the copolymer.

Aspect 18. The capped poly(arylene ether) copolymer of Aspect 17, wherein less than 20 parts per million by weight of the R⁵ groups are (C₁-C₆-hydrocarbyl)(C₁-C₆-hydrocarbyl)aminomethylene groups, based on the total parts by weight of the copolymer.

Aspect 19. A curable composition, comprising a thermosetting resin and the capped poly(arylene ether) copolymer of Aspect 17 or 18.

Aspect 20. A cured composition obtained by heating the curable composition of Aspect 19 for a time and temperature sufficient to effect curing.

Aspect 21. An article comprising a cured composition of Aspect 20.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The singular forms “a” “an,” and “the” include plural referents unless the context clearly dictates otherwise. The suffix “(s)” as used herein is intended to include both the singular and the plural of the term that it modifies, thereby including at least one of that term (e.g., the colorant(s) includes at least one colorants). “Combinations” is inclusive of blends, mixtures, alloys, reaction products, and the like. “Or” means “and/or” unless clearly indicated otherwise by context. Reference to “an aspect” means that a particular element described in connection with the aspect is included in at least one aspect described herein and may or may not be present in other aspects. A “combination thereof” is open and includes any combination comprising at least one of the listed elements, optionally together with a like or equivalent element not listed. The described elements may be combined in any suitable manner in the various aspects. “Optional” or “optionally” means that the subsequently described event or circumstance can or cannot occur, and that the description includes instances where the event occurs and instances where it does not. The endpoints of all ranges directed to the same component or property are inclusive of the endpoint and independently combinable. Disclosure of a narrower range or more specific group in addition to a broader range is not a disclaimer of the broader range or larger group.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. Also as used herein, the term “combination” is inclusive of blends, mixtures, alloys, reaction products, and the like.

As used herein, the terms “hydrocarbyl” and “hydrocarbon” refer broadly to a substituent comprising carbon and hydrogen, optionally with 1 to 3 heteroatoms, for example, oxygen, nitrogen, halogen, silicon, sulfur, or a combination thereof; “alkyl” refers to a straight or branched chain, saturated monovalent hydrocarbon group; “alkylene” refers to a straight or branched chain, saturated, divalent hydrocarbon group; “alkylidene” refers to a straight or branched chain, saturated divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicyclic hydrocarbon group having at least three carbon atoms; “cycloalkylene” means a divalent cycloalkyl group; “cycloalkenyl” refers to a non-aromatic cyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

As used herein, when a definition is not otherwise provided, the term “amino” refers to a monovalent radical of the formula —NRR′ wherein R and R′ are independently hydrogen or a C₁-C₃₀ hydrocarbyl, for example a C₁-C₂₀ alkyl group or a C₆-C₃₀ aryl group. The term “aminomethylene” refers to a radical of the formula —CH₂—NRR′, wherein R and R′ are each independently a C₁-C₆-hydrocarbyl. The term “carboxylic acid” refers to a radical of the formula —COOH, wherein the carbon atom is covalently bonded to another carbon atom. The term “thiocarboxylic acid” refers to a radical of the formula —C═S(OH) or —C═O(SH). The term “formyl” refers to a radical that is an aldehyde of the formula —C═O(H). The term imidate refers to a radical of the formula —C═NR(R′), wherein R and R′ are each independently a C₁-C₁₂ hydrocarbyl. The term “nitrile” refers to a radical of the formula —CN. The term “hydrocarbylthio” refer to a radical of the formula —SR, wherein R is a C₁-C₁₂ hydrocarbyl.

“Halogen” or “halogen atom” as used herein may mean a fluorine, chlorine, bromine, or iodine atom. The prefix “halo” means a group or compound including one more halogens. The prefix “hetero” means that the compound or group includes at least one member that is a heteroatom (e.g., 1, 2, or 3 heteroatom(s)), wherein the heteroatom(s) is each independently N, O, S, Si, or P. The suffix “oxy” indicates that the open valence of the group is on an oxygen atom and the suffix “thio” indicates that the open valence of the group is on a sulfur atom.

“(Meth)acryl” as used herein is a generic term for an acryl (which includes both acrylics and acrylates) and a methacryl (which includes both (meth)acrylics and (meth)acrylates). Thus, a compound having the prefix (meth), such as (meth)acrylic acid, may refer to compounds having the prefix “meth” and compounds not having the prefix “meth.”

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents and/or variables are permissible provided that the substitutions do not significantly adversely affect synthesis or use of the compound. Exemplary groups that can be present on a “substituted” position include, but are not limited to, nitro; cyano (i.e., nitrile); azido; hydroxyl; halogen; thiol (—SH); thiocyano (—SCN); C₂-C₆ alkanoyl (e.g., acyl); carboxamido; C₁-C₆ alkylthio; C₁-C₆ or C₁-C₃ alkyl; C₃₋₁₂ cycloalkyl; C₂₋₆ alkenyl; C₂₋₆ alkynyl (including groups having at least one unsaturated linkages and from 2 to 8, or 2 to 6 carbon atoms); C₁-C₆ or C₁-C₃ haloalkyl; C₁-C₆ or C₁-C₃ alkoxy; C₁-C₆ or C₁-C₃ haloalkoxy; C₁-C₆ or C₁-C₃ alkylsulfonyl; C₁-C₆ or C₁-C₃ alkylsulfinyl; aminodi(C₁-C₆ or C₁-C₃)alkyl; C₆-C₁₂ aryl having at least one aromatic ring (e.g., phenyl, biphenyl, naphthyl, or the like, each ring either substituted or unsubstituted aromatic); C₆-C₁₀ aryloxy; C₆₋₁₂ arylsulfonyl (—S(═O)₂-aryl); tosyl (CH₃C₆H₄SO₂—); C₇-C₁₉ arylalkylene having 1 to 3 separate or fused rings and from 6 to 18 ring carbon atoms; C₇-C₁₂ alkylarylene (e.g., toluyl); or arylalkoxy having 1 to 3 separate or fused rings and from 6 to 18 ring carbon atoms, with benzyloxy being an exemplary arylalkoxy. When a compound is substituted, the indicated number of carbon atoms is the total number of carbon atoms in the compound or group, including those of any substituents.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A process for forming a capped poly(arylene ether) copolymer, the process comprising:
combining an acid catalyst and an uncapped poly(arylene ether) composition comprising an uncapped poly(arylene ether) copolymer comprising a phenolic end group ortho-substituted with a (C₁-C₁₂-hydrocarbyl)(C₁-C₁₂-hydrocarbyl)aminomethylene group to form a first reaction mixture;
reacting the (C₁-C₁₂-hydrocarbyl)(C₁-C₁₂-hydrocarbyl)aminomethylene group of the uncapped poly(arylene ether) copolymer in the presence of the acid catalyst, under conditions effective to cleave a (C₁-C₁₂-hydrocarbyl)(C₁-C₁₂-hydrocarbyl)amino group from the uncapped poly(arylene ether) copolymer, to form a second reaction mixture;
adding a nucleophilic catalyst and a capping agent to the second reaction mixture; and
reacting the capping agent and the uncapped poly(arylene ether) copolymer under conditions effective to provide a product mixture comprising the capped poly(arylene ether) copolymer.

2. The process of claim 1, wherein the capping agent is an anhydride capping agent, an acid halide capping agent, or a combination thereof.

3. The process of claim 1, wherein the acid catalyst is the corresponding acid of the capping agent.

4. The process of claim 1, wherein the conditions effective to cleave the (C₁-C₁₂-hydrocarbyl)(C₁-C₁₂-hydrocarbyl)amino group comprise azeotropic distillation of water from the first reaction mixture at a temperature of 70° C. to 200° C. and a pressure of 100 to 1000 kPa.

5. The process of claim 1, wherein the uncapped poly(arylene ether) composition is a product mixture of the reaction of a monohydric phenol, a dihydric phenol, a metal catalyst, and a (C₁-C₁₂-hydrocarbyl)(C₁-C₁₂-hydrocarbyl)amine.

6. The process of claim 1, wherein the capping agent comprises an anhydride, or a corresponding acid chloride, of the formula 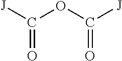
wherein each occurrence of J is independently 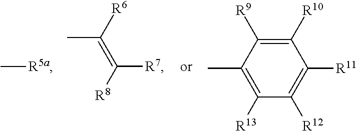
wherein
R^{5a} is C₁-C₁₂ hydrocarbyl optionally substituted with one or two carboxylic acid groups, each occurrence of R⁶, R⁷, and R⁸ is independently hydrogen, C₁-C₁₈ hydrocarbyl, C₂-C₁₈ hydrocarbyloxycarbonyl, nitrile, formyl, carboxylic acid, imidate, or thiocarboxylic acid, and
each occurrence of R⁹, R¹⁰, R¹¹, R¹², and R¹³ is independently hydrogen, halogen, C₁-C₁₂ alkyl, C₂-C₁₂ alkenyl, hydroxy, amino, or carboxylic acid.

7. The process of claim 1, wherein the uncapped poly(arylene ether) composition comprises an uncapped poly(phenylene ether) copolymer of the formula 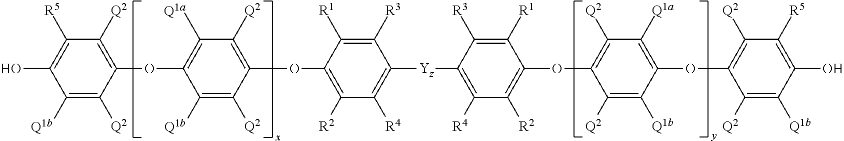
wherein
Q^{1a} a C₁-C₁₂ primary or secondary alkyl,
Q^{1b} is halogen, C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms,
each occurrence of Q² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms;
each occurrence of R¹, R², R³, and R⁴ is independently hydrogen, halogen, C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms;
z is 0 or 1;
x and y represent the relative mole ratios of the phenylene ether units; and
Y is divalent linking group of the formulas 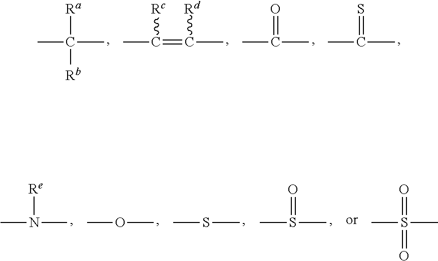
wherein
each occurrence of R^{a}, R^{b}, R^{c}, R^{d}, and R^{e} is independently hydrogen, C₁-C₁₂ hydrocarbyl, or C₁-C₆ hydrocarbylene, optionally wherein R^{a} and R^{b} or R^{c} and R^{d} together are a C₄-C₈ alkylene group; and
each occurrence of R⁵ is independently Q^{1a} or a (C₁-C₆-hydrocarbyl)(C₁-C₆-hydrocarbyl)aminomethylene group, with the proviso that at least 50 parts per million by weight of the R⁵ groups are (C₁-C₆-hydrocarbyl)(C₁-C₆-hydrocarbyl)aminomethylene groups, based on the total parts by weight of the copolymer.

8. The process of claim 1, wherein
the capping agent is acrylic anhydride, methacrylic anhydride, or a combination thereof; and
the uncapped poly(arylene ether) composition comprises an uncapped poly(phenylene ether) copolymer of the formula 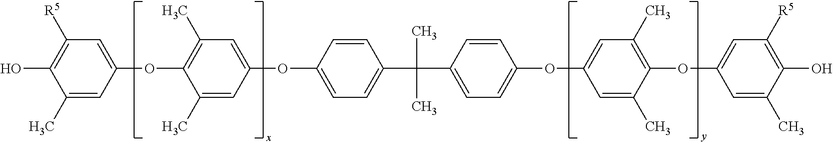
wherein x and y represent the relative mole ratios of the phenylene ether units; and
each occurrence of R⁵ is independently methyl or a di-(n-butyl)aminomethylene group, with the proviso that at least 50 parts per million by weight of the R⁵ groups are di-(n-butyl)aminomethylene groups.

9. The process of claim 1, further comprising isolating the capped poly(arylene ether) copolymer from the product mixture.

10. The process of claim 1, wherein the capped poly(arylene ether) copolymer in the product mixture comprises at least 80% fewer (C₁-C₆-hydrocarbyl)(C₁-C₆-hydrocarbyl)aminomethylene groups than the uncapped poly(arylene ether) copolymer in the first reaction mixture, each as determined by ¹H NMR spectroscopy.

11. The process of claim 1, wherein the capped poly(arylene ether) copolymer has
an absolute number average molecular weight of 500 to 25,000 grams per mole, as determined by Gel Permeation Chromatography; and
an intrinsic viscosity of 0.04 to 1.5 deciliters/gram, as measured in chloroform at 25° C.

12. A capped poly(arylene ether) copolymer made by the method of claim 1, and having the formula: 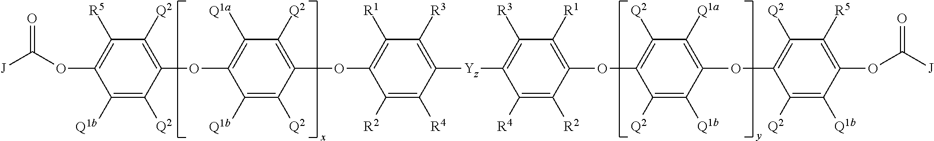
wherein:
Q^{1a} a C₁-C₁₂ primary or secondary alkyl,
Q^{1b} is halogen, C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms,
each occurrence of Q² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms
each occurrence of R¹, R², R³, and R⁴ is independently hydrogen, halogen, C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms;
z is 0 or 1;
x and y represent the relative mole ratios of the arylene ether units;
Y is divalent linking group of the formulas 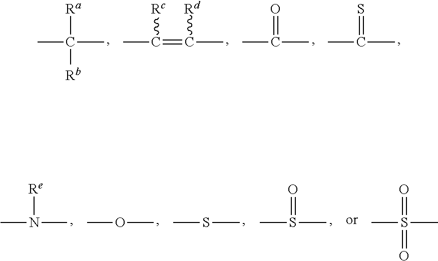
wherein each occurrence of R^{a}, R^{b}, R^{c}, R^{d}, and R^{e} is independently hydrogen, C₁-C₁₂ hydrocarbyl, or C₁-C₆ hydrocarbylene, optionally wherein R^{a} and R^{b} or R^{c} and R^{d} together are a C₄-C₈ alkylene group; and each occurrence of R⁵ is independently Q^{1a} or a (C₁-C₆-hydrocarbyl)(C₁-C₆-hydrocarbyl)aminomethylene group;
wherein less than 100 parts per million by weight of the R⁵ groups are (C₁-C₆-hydrocarbyl)(C₁-C₆-hydrocarbyl)aminomethylene groups, based on the total parts by weight of the copolymer; and
wherein each occurrence of J is independently 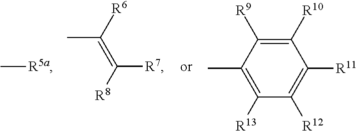
wherein
R^{5a} is C₁-C₁₂ hydrocarbyl optionally substituted with one or two carboxylic acid groups, each occurrence of R⁶, R⁷, and R⁸ is independently hydrogen, C₁-C₁₈ hydrocarbyl, C₂-C₁₈ hydrocarbyloxycarbonyl, nitrile, formyl, carboxylic acid, imidate, or thiocarboxylic acid, and
each occurrence of R⁹, R¹⁰, R¹¹, R¹², and R¹³ is independently hydrogen, halogen, C₁-C₁₂ alkyl, C₂-C₁₂ alkenyl, hydroxy, amino, or carboxylic acid.

13. A curable composition, comprising a thermosetting resin and the capped poly(arylene ether) copolymer of claim 12.

14. A cured composition obtained by heating the curable composition of claim 13 for a time and temperature sufficient to effect curing.

15. An article comprising a cured composition of claim 14.

16. The process of claim 1, wherein the (C₁-C₆-hydrocarbyl)(C₁-C₆-hydrocarbyl)aminomethylene group is a di(C₁-C₆-alkyl)aminomethylene group.

17. The process of claim 1, further comprising combining a second portion of the capping agent and the uncapped poly(arylene ether) copolymer under conditions effective to provide the acid catalyst in the first reaction mixture.

18. The process of claim 1, wherein the capping agent has the formula 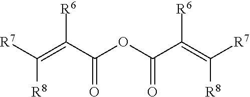
wherein each occurrence of R⁶, R⁷, and R⁸ is independently C₁-C₁₈ hydrocarbyl, C₂-C₁₂ hydrocarbyloxycarbonyl, nitrile, formyl, carboxylic acid, imidate, or thiocarboxylic acid.

19. The process of claim 18, wherein the capping agent is acetic anhydride, succinic anhydride, allyl succinic anhydride, propionic anhydride, isobutyric anhydride, isobutenyl succinic anhydride, butenyl succinic anhydride, maleic anhydride, glutaric anhydride, adipic anhydride, salicylic anhydride, phthalic anhydride, acrylic anhydride, methacrylic anhydride, 4-vinylbenzoic anhydride, a corresponding acid chloride thereof, or a combination thereof.

20. The process of claim 1, wherein the capped poly(arylene ether) copolymer in the product mixture comprises no (C₁-C₆-hydrocarbyl)(C₁-C₆-hydrocarbyl)aminomethylene groups as determined by ¹H NMR spectroscopy.
